(19) United States
(12) Patent Application Publication
(10) Pub. No.: US 2023/0417543 A1
(43) Pub. Date: Dec. 28, 2023

(54) OPTICAL-BASED VALIDATION OF ORIENTATIONS OF SURFACES

(71) Applicant: LUMUS LTD., Nes Ziona (IL)

(72) Inventor: Ido EISENBERG, Nes Ziona (IL)

(21) Appl. No.: 18/036,407

(22) PCT Filed: Nov. 18, 2021
(86) PCT No.: PCT/IL2021/051377

§ 371 Date: May 11, 2023

Related U.S. Application Data
(60) Provisional application No. 63/115,125, filed on Nov. 18, 2020.

(51) Int. Cl. G01B 11/26

(52) U.S. Cl. CPC G01B 11/26

(57) ABSTRACT

Disclosed herein is an optical-based method for validating angles between external, flat surfaces of samples. The method includes: (i) providing a sample including an external, flat first surface and an external, flat second surface nominally inclined at a nominal angle relative to the first surface; (ii) generating a first incident light beam (LB), directed at the first surface, and a second incident LB parallel to the first incident LB; (iii) obtaining a first returned LB by reflection of the first incident LB off the first surface; (iv) obtaining a second returned LB by folding the second incident LB at the nominal angle, reflecting the folded LB off the second surface, and folding the reflected LB at the nominal angle; (v) measuring a first angular deviation between the returned LBs; and (vi) deducing an actual inclination angle between the first second surfaces, based at least on the measured first angular deviation.

### TECHNICAL FIELD

The present disclosure relates generally to methods and systems for surface-metrology of samples.

### BACKGROUND

Optical elements, such as glass prisms, are increasingly required to exhibit higher angular tolerances between surfaces thereof. To meet the required angular tolerances, high-precision metrology for validating the angles between surfaces is necessitated, which, in turn, necessitates use of high-end optical components, and complex alignment and calibration procedures. There is thus an unmet need in the art for simple and easily implementable metrology techniques, which avoid the use of high-end optical components, thereby addressing mass production demands

### SUMMARY

Aspects of the disclosure, according to some embodiments thereof, relate to methods and systems for surface-metrology of samples. More specifically, but not exclusively, aspects of the disclosure, according to some embodiments thereof, relate to optical-based methods and systems for metrology of external surfaces of samples.

The present application discloses fast, simple, and precise methods and systems for measuring the inclination of an external, flat surface of a sample relative to one or more other external, flat surfaces thereof. To achieve this, two parallel-prepared light beams (LBs) may be employed: The first LB is impinged on an external, flat first surface of the sample. The second LB is redirected so as to nominally impinge on an external, flat second surface of the sample—whose inclination angle relative to the first surface is to be validated—at the same incidence angle as the first LB. The angular deviation between the reflected LBs, after the second reflected LB has been redirected again, is then measured. Advantageously, according to some embodiments of the disclosed technology, a collimated light source, a light sensor (or image sensor), a light folding component to redirect the second LB, and orienting infrastructure to orient the sample suffice in order to validate inclinations of external, flat surfaces.

Thus, according to an aspect of some embodiments, there is provided an optical-based method for validating angles between external, flat surfaces of samples. The method includes:
Providing a sample including an external, flat first surface and an external, flat second surface nominally inclined (intended by design and fabrication to be inclined) at a nominal inclination angle relative to the first surface.
Generating a first incident light beam (LB), directed at the first surface, and a second incident LB parallel to the first incident LB.
Obtaining a first returned LB by reflection of the first incident LB off the first surface.
Obtaining a second returned LB by folding the second incident LB at a light folding angle nominally equal to the nominal inclination angle, reflecting the folded LB off the second surface, and folding the reflected LB at the light folding angle.
Measuring a first angular deviation of the second returned LB relative to the first returned LB.
Deducing an actual inclination angle of the second surface relative to the first surface, based at least on the measured first angular deviation.

According to some embodiments of the method, the deduced actual inclination angle equals α+δ/2, or about equals α+δ/2 (e.g. the deduced actual inclination angle is between α+0.475·δ and α+0.525·δ, between α+0.45·δand α+0.55·δ, or even between α+0.4 6 and α+0.6·δ, each possibility corresponds to separate embodiments). α is the nominal inclination angle. δ is the measured value of the first angular deviation.

According to some embodiments of the method, the first incident LB is directed at the first surface perpendicularly to the first surface.

According to some embodiments of the method, the folding is implemented utilizing a light folding component (LFC), which is or includes a prism, one or more mirrors, and/or a diffraction grating.

According to some embodiments of the method, the light folding angle is insensitive to variations in a pitch of the LFC.

According to some embodiments of the method, the LFC is or includes a pentaprism or a like-function prism, or a pair of mirrors set at an angle relative to one another or a like-function mirror arrangement.

According to some embodiments of the method, the sample is or includes glass, polymer, metal, crystal, and/or a combination thereof.

According to some embodiments of the method, the sample is a prism.

According to some embodiments of the method, the second surface does not share a common edge with the first surface.

According to some embodiments of the method, the first incident LB and the second incident LB are complementary portions of a single collimated LB.

According to some embodiments of the method, the first incident LB and the second incident LB are prepared by blocking one or more portions of a single collimated LB.

According to some embodiments of the method, the single collimated LB is polychromatic.

According to some embodiments of the method, the single collimated LB is a laser beam.

According to some embodiments of the method, the first angular deviation is measured using an autocollimator.

According to some embodiments of the method, the first angular deviation between the returned LB s is equal to, or about equal to, Δu/f. Δu is a difference between a coordinate of a first spot and a corresponding coordinate of a second spot on a photosensitive surface of the autocollimator. f is the focal length of a collimating lens of the autocollimator. The first spot is formed by the first returned LB and the second spot is formed by the second returned LB.

According to some embodiments of the method, the method further includes an initial calibration stage, wherein a gold standard sample is utilized to calibrate the system.

According to some embodiments of the method, the nominal inclination angle is obtuse.

According to some embodiments of the method, the nominal inclination angle is acute.

According to some embodiments of the method, wherein the nominal inclination angle is 90° and the sample includes an external, flat third surface parallel to the first surface, the method further includes, following the measuring of the first angular deviation:
Flipping the sample, so as to invert the first and third surfaces while maintaining a nominal orientation of the second surface relative to the LFC.
Preparing a third incident LB, directed at the third surface, and a fourth incident LB parallel to the third incident LB.
Obtaining a third returned LB by reflection of the third incident LB off the third surface.
Obtaining a fourth returned LB by folding the fourth incident LB at a light folding angle nominally equal to the nominal inclination angle, reflection thereof off the second surface, and folding thereof at the light folding angle.
Measuring a second angular deviation of the fourth returned LB relative to the third returned LB.

In the deducing of the actual inclination angle, the actual inclination angle is deduced additionally taking into account the measured second angular deviation.

According to some embodiments of the method, an uncertainty in the parallelism of the first surface and the third surface is smaller than a required measurement precision of the actual inclination angle.

According to some embodiments of the method, the deduced actual inclination angle is equal to χ+(δ₁−δ₂)/4, or about equal to χ+(δ₁−δ₂)/4 (e.g. the deduced actual inclination angle is between χ+0.235·(δ₁−δ₂) and χ+0.265·(δ₁−δ₂), between χ+0.225·(δ₁−δ₂) and χ+0.275·(δ₁−δ₂), or even between χ+0.2·(δ₁−δ₂) and χ+0.3·(δ₁−δ₂), each possibility corresponds to separate embodiments). χ is the nominal inclination angle. δ₁ and is the measured first angular deviation and δ₂ is the measured second angular deviation.

According to some embodiments of the method, the method further includes, contingent on the sample including an external, flat fourth surface, which is nominally parallel to the second surface, suppressing internal reflection from the fourth surface.

According to an aspect of some embodiments, there is provided an optical-based system for validating angles between external, flat surfaces of samples. The system includes:
A light folding component (LFC) nominally configured to fold light incident thereon at a nominal inclination angle defined by an external, flat first surface of a sample and an external, flat second surface of the sample.
An illumination and collection arrangement (ICA) including:
   A light generation assembly to (a) project a first incident light beam (LB) on the first surface, so as to generate a first returned LB by reflection off the first surface, and (b) project a second incident LB on the LFC, in parallel to the first incident LB, so as to generate a second returned LB, by reflection off the second surface and repassage via the LFC.
   At least one sensor, configured to measure a first angular deviation between the first returned LB and the second returned LB, and/or an eyepiece assembly configured to enable manually measuring the first angular deviation.

The measured first angular deviation is indicative of an actual inclination angle of the second surface relative to the first surface.

According to some embodiments of the system, the light generation assembly includes a light source and optical equipment.

According to some embodiments of the system, the system further includes orienting infrastructure configured to orient the sample such that the first incident LB normally (i.e. perpendicularly) impinges on the first surface, and/or a folded LB, obtained by folding of the second incident LB by the LFC, nominally normally impinges on the second surface.

According to some embodiments of the system, wherein the system includes the at least one sensor, the system further includes a computational module configured to compute the actual inclination angle of the second surface relative to the first surface, based at least on the measured first angular deviation.

According to some embodiments of the system, wherein the system includes the at least one sensor, the ICA is or includes an autocollimator. The autocollimator includes the light source and the at least one sensor.

According to some embodiments of the system, the ICA further includes a pair of blocking elements configured to allow selectively blocking each of the first incident LB and the second incident LB. According to some such embodiments, the blocking elements are shutters that fully block light beams incident thereon.

According to some embodiments of the system, the LFC includes a prism, one or more mirrors, and/or a diffraction grating.

According to some embodiments of the system, a light folding angle of the LFC is insensitive to variations in a pitch thereof.

According to some embodiments of the system, the LFC is or includes a pentaprism or a like-function prism, or a pair of mirrors set at an angle relative to one another or a like-function mirror arrangement.

According to some embodiments of the system, the system is configured to facilitate flipping the sample.

According to some embodiments of the system, wherein the system includes the at least one sensor and the computational module. The nominal inclination angle is 90° and the sample further includes an external, flat third surface, which is parallel to the first surface. The computational module is configured to compute the actual inclination angle additionally taking into account a measured second angular deviation of a fourth returned LB relative to a third returned LB. With the sample flipped, such that the first surface and the third surface are inverted, and a nominal orientation of the second surface relative to the LFC is maintained: (a′) the third returned LB is obtained by projecting a third incident light beam on the third surface of the sample, so as to generate the third returned LB by reflection off the third surface, and (b′) the fourth returned LB is obtained by projecting a fourth incident LB on the LFC, in parallel to the third incident LB, so as to generate the fourth returned LB by folding thereof by the LFC, reflection off the second surface, and repassage via the LFC.

According to some embodiments of the system, the computational module is further configured to compute an uncertainty in the obtained value of the actual inclination angle taking into account at least manufacturing tolerances and imperfections of the LFC and the ICA.

According to some embodiments of the system, wherein the system includes the orienting infrastructure, the computational module is configured to compute the uncertainty in the computed value of the actual inclination angle additionally taking into account manufacturing tolerances and imperfections of the orienting infrastructure.

According to some embodiments of the system, the light generation assembly includes a light source and optical equipment. The light source is configured to generate a single LB. The optical equipment is configured to collimate the single LB.

According to some embodiments of the system, the first incident LB and the second incident LB are complementary portions of the collimated LB.

According to some embodiments of the system, the light source is a polychromatic light source.

According to some embodiments of the system, the light source is a monochromatic light source.

According to some embodiments of the system, the light source is configured to generate a laser beam.

According to some embodiments of the system, the at least one sensor includes a light sensor and/or an image sensor (e.g. a camera).

According to an aspect of some embodiments, there is provided a method for manufacturing samples having a pair of external, flat surfaces set at a nominal angle relative to one another. The method includes stages of:
Providing a raw sample.
Processing the raw sample to obtain a processed sample including an external, flat first surface and an external, flat second surface, which is set at a test angle relative to the first surface.
Measuring the test angle using the optical-based method of described above.
If the test angle differs from a nominal angle by more than a predefined difference, subjecting the processed sample to further processing, to obtain a reprocessed sample.
Repeating the stages of measuring and, if necessary, reprocessing until the difference between the test angle of the reprocessed sample and the nominal angle is smaller than the predefined difference.

Certain embodiments of the present disclosure may include some, all, or none of the above advantages. One or more other technical advantages may be readily apparent to those skilled in the art from the figures, descriptions, and claims included herein. Moreover, while specific advantages have been enumerated above, various embodiments may include all, some, or none of the enumerated advantages.

Unless otherwise defined, all technical and scientific terms used herein have the same meaning as commonly understood by one of ordinary skill in the art to which this disclosure pertains. In case of conflict, the patent specification, including definitions, governs. As used herein, the indefinite articles “a” and “an” mean “at least one” or “one or more” unless the context clearly dictates otherwise.

Unless specifically stated otherwise, as apparent from the disclosure, it is appreciated that, according to some embodiments, terms such as “processing”, “computing”, “calculating”, “determining”, “estimating”, “assessing”, “gauging” or the like, may refer to the action and/or processes of a computer or computing system, or similar electronic computing device, that manipulate and/or transform data, represented as physical (e.g. electronic) quantities within the computing system's registers and/or memories, into other data similarly represented as physical quantities within the computing system's memories, registers or other such information storage, transmission or display devices.

Embodiments of the present disclosure may include apparatuses for performing the operations herein. The apparatuses may be specially constructed for the desired purposes or may include a general-purpose computer(s) selectively activated or reconfigured by a computer program stored in the computer. Such a computer program may be stored in a computer readable storage medium, such as, but not limited to, any type of disk including floppy disks, optical disks, CD-ROMs, magnetic-optical disks, read-only memories (ROMs), random access memories (RAMs), electrically programmable read-only memories (EPROMs), electrically erasable and programmable read only memories (EEPROMs), magnetic or optical cards, or any other type of media suitable for storing electronic instructions, and capable of being coupled to a computer system bus.

The processes and displays presented herein are not inherently related to any particular computer or other apparatus. Various general-purpose systems may be used with programs in accordance with the teachings herein, or it may prove convenient to construct a more specialized apparatus to perform the desired method(s). The desired structure(s) for a variety of these systems appear from the description below. In addition, embodiments of the present disclosure are not described with reference to any particular programming language. It will be appreciated that a variety of programming languages may be used to implement the teachings of the present disclosure as described herein.

Aspects of the disclosure may be described in the general context of computer-executable instructions, such as program modules, being executed by a computer. Generally, program modules include routines, programs, objects, components, data structures, and so forth, which perform particular tasks or implement particular abstract data types. Disclosed embodiments may also be practiced in distributed computing environments where tasks are performed by remote processing devices that are linked through a communications network. In a distributed computing environment, program modules may be located in both local and remote computer storage media including memory storage devices.

### BRIEF DESCRIPTION OF THE FIGURES

Some embodiments of the disclosure are described herein with reference to the accompanying figures. The description, together with the figures, makes apparent to a person having ordinary skill in the art how some embodiments may be practiced. The figures are for the purpose of illustrative description and no attempt is made to show structural details of an embodiment in more detail than is necessary for a fundamental understanding of the disclosure. For the sake of clarity, some objects depicted in the figures are not drawn to scale. Moreover, two different objects in the same figure may be drawn to different scales. In particular, the scale of some objects may be greatly exaggerated as compared to other objects in the same figure.

In the figures:

FIG. 1A schematically depicts an optical-based system for external, flat surface metrology of samples, during inspection of a sample, according to some embodiments;

FIG. 1B presents a schematic, perspective view the sample of FIG. 1A, during the inspection thereof, according to some embodiments;

FIG. 1C schematically depicts spots on a photosensitive surface of a sensor of the system of FIG. 1A, according to some embodiments;

FIGS. 2A and 2B schematically depicts an optical-based system for verifying perpendicularity of one external, flat surface of a sample with respect to two other parallel, external, flat surfaces thereof, during inspection of the sample, the system corresponds to specific embodiments of the system of FIG. 1A;

FIGS. 2C and 2D schematically depict spots on a photosensitive surface of a sensor of the system of FIGS. 2A and 2B, according to some embodiments;

FIG. 3 schematically depicts an optical-based system for external, flat surface metrology of samples, during inspection of a sample, the system corresponds to specific embodiments of the system of FIG. 1A, wherein a light folding component of the system is a prism;

FIG. 4 schematically depicts an optical-based system for external, flat surface metrology of samples, during inspection of a sample, the system corresponds to specific embodiments of the system of FIG. 1A, wherein a light folding component of the system is a mirror;

FIG. 5 presents a flowchart of an optical-based method for external, flat surface metrology of samples, according to some embodiments; and

FIG. 6 presents a flowchart of an optical-based method for validating perpendicularity of one external, flat surface of a sample with respect to two other parallel, external, flat surfaces thereof, according to some embodiments.

### DETAILED DESCRIPTION

The principles, uses, and implementations of the teachings herein may be better understood with reference to the accompanying description and figures. Upon perusal of the description and figures present herein, one skilled in the art will be able to implement the teachings herein without undue effort or experimentation. In the figures, same reference numerals refer to same parts throughout.

In the description and claims of the application, the words “include” and “have”, and forms thereof, are not limited to members in a list with which the words may be associated.

As used herein, the term “about” may be used to specify a value of a quantity or parameter (e.g. the length of an element) to within a continuous range of values in the neighborhood of (and including) a given (stated) value. According to some embodiments, “about” may specify the value of a parameter to be between 80% and 120% of the given value. For example, the statement “the length of the element is equal to about 1 m” is equivalent to the statement “the length of the element is between 0.8 m and 1.2 m”. According to some embodiments, “about” may specify the value of a parameter to be between 90% and 110% of the given value. According to some embodiments, “about” may specify the value of a parameter to be between 95% and 105% of the given value.

As used herein, according to some embodiments, the terms “substantially” and “about” may be interchangeable.

For ease of description, in some of the figures a three-dimensional cartesian coordinate system is introduced. It is noted that the orientation of the coordinate system relative to a depicted object may vary from one figure to another. Further, the symbol ⊙ may be used to represent an axis pointing “out of the page”, while the symbol ⊗ may be used to represent an axis pointing “into the page”.

In the figures, optional elements and optional stages (in flowcharts) are delineated by a dashed line.

### Systems

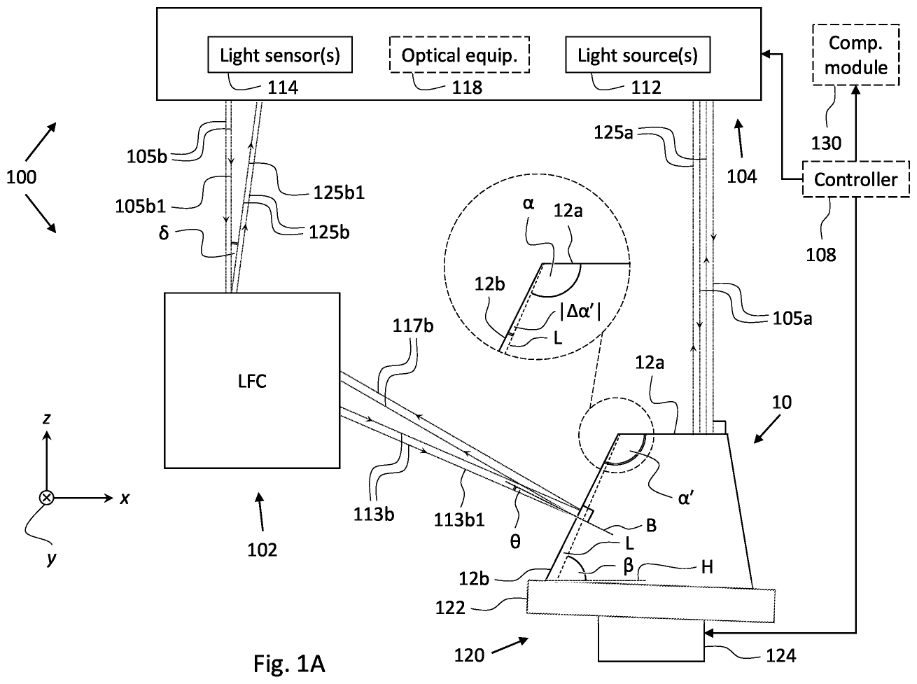

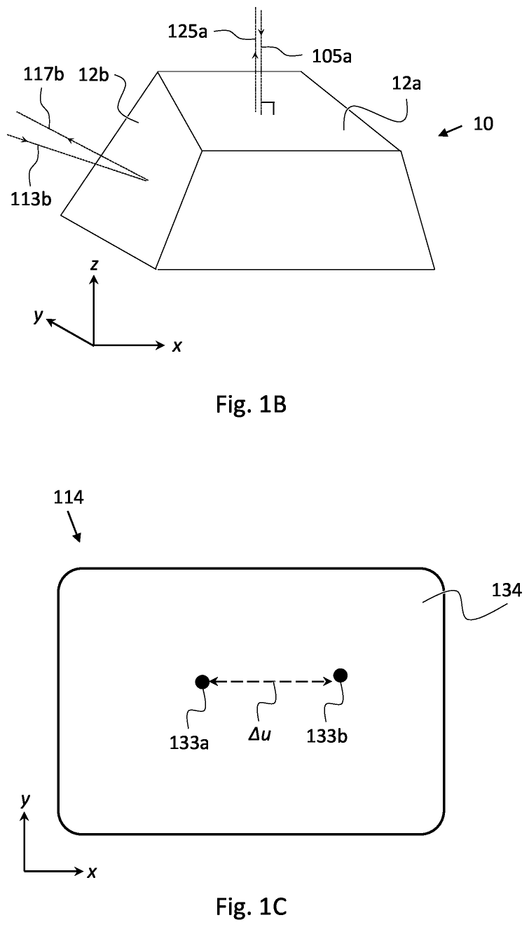

According to an aspect of some embodiments, there is provided an optical-based system for metrology of external, flat surfaces of samples. FIG. 1A schematically depicts such a system, an optical-based system 100, according to some embodiments. Optical-based system 100 is configured for validating the angle between two external, flat surfaces of a sample. FIG. 1A provides a side-view of system 100 and a sample 10, according to some embodiments. (It is to be understood that sample 10 does not constitute a part of system 100.) Sample 10 is shown being inspected by system 100. Sample 10 may be any opaque or partially transparent element having two or more reflective, flat (external) surfaces, which are set at a (non-vanishing) angle relative to one another. According to some embodiments, sample 10 may be made of glass, polymer, metal, crystal, and/or a combination thereof. According to some embodiments, sample 10 may be an optical element, such as a prism, a waveguide, or a beam splitter. According to some embodiments, the prism may be shaped as a polyhedron. According to some embodiments, and as depicted in FIG. 1A, a cross-section of sample 10, taken in parallel to the zx-plane, may define a polygon.

Sample 10 includes an external, flat first surface 12a (i.e. a first external surface, which is flat) and an external, flat second surface 12b (i.e. a second external surface, which is flat). Sample 10 is manufactured to exhibit a nominal inclination angle α between first surface 12a and second surface 12b. However, due to fabrication imperfections an actual inclination angle between first surface 12a and second surface 12b, labelled in FIG. 1A as a′, will generally differ from the nominal inclination angle α. A dashed line L is shown in FIG. 1A intersecting second surface 12b and is inclined at the nominal inclination angle a relative to first surface 12a. The dashed line L indicates the intended inclination of second surface 12b. The nominal inclination angle α may be acute (i.e. a<90°), obtuse (i.e. a >90°), or equal to 90°.

Also shown in FIG. 1A is a (straight) dotted line H extending in parallel to first surface 12a and intersecting second surface 12b. A supplementary angle to the nominal inclination angle α, labelled as β (i.e. β=180°−α), is spanned between second surface 12b and the dotted line H.

According to some embodiments, system 100 includes a light folding component (LFC) 102 and an illumination and collection arrangement (or assembly; ICA) 104. System 100 may further include a controller 108 functionally associated with ICA 104 and configured to control operation thereof. According to some embodiments, and as depicted in FIG. 1A, ICA 104 includes a light source 112 (or a plurality of light sources) and a sensor 114 (or a plurality of sensors), and, optionally, optical equipment 118. According to some embodiments, sensor 114 is a light sensor or an image sensor (or the plurality of sensors includes one or more light sensors and/or one or more image sensors, e.g. cameras). According to some alternative embodiments, not depicted in FIG. 1A, ICA 104 includes an eyepiece assembly in place of sensor 114, being thereby configured for visual determination (i.e. by eye) of the actual inclination angle. Light source 112 and optical equipment 118 are collectively referred to as “light generation assembly”.

As described in detail below, ICA 104 is configured to output a pair of parallel light beams (LBs): a first LB 105a (also referred to as “first incident LB”; indicated in FIG. 1A by a pair of parallel light rays) and a second LB 105b (also referred to as “second incident LB”; indicated in FIG. 1A by a pair of parallel light rays). According to some such embodiments, optical equipment 118 may be configured to collimate light generated by light source 112, and thereby produce the (parallel) incident LBs 105a and 105b. According to such embodiments, optical equipment 118 may include a collimating lens or a collimating lens assembly (not shown). According to some embodiments, incident LBs 105a and 105b may form complementary portions of a collimated light beam (which has been focused by the collimating lenses or collimating lens assembly). Alternatively, according to some embodiments, incident LBs 105a and 105b may be spaced apart (and parallel). According to some such embodiments, optical equipment 118 may further include one or more optical filters (e.g. a light absorbing filter or an opaque plate), and/or one or more beam splitters, and, optionally, one or more mirrors (not shown), configured to prepare from the collimated LBs a pair of spaced apart and parallel LBs.

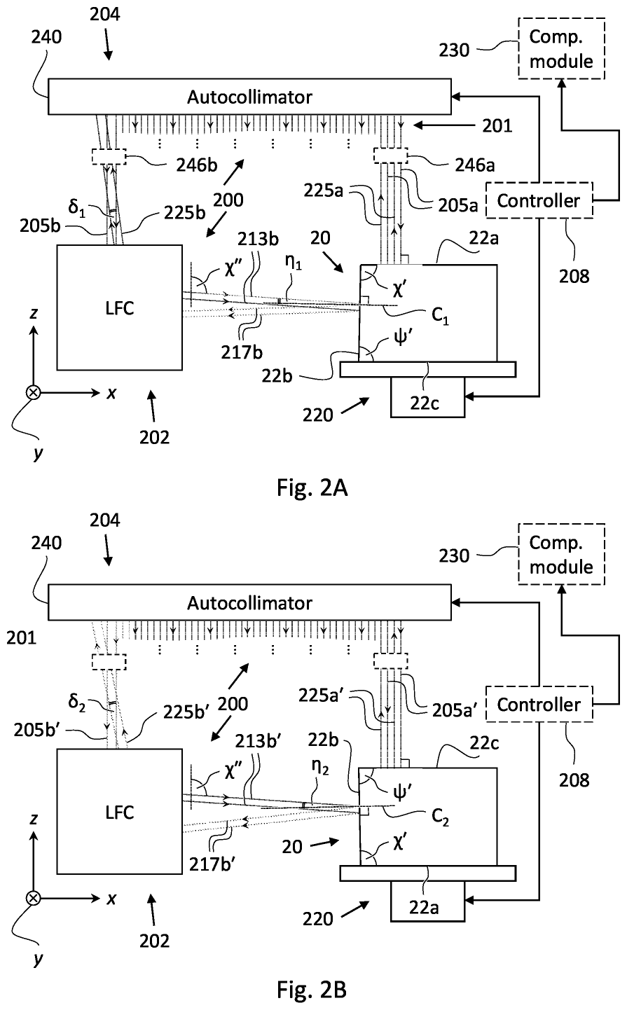

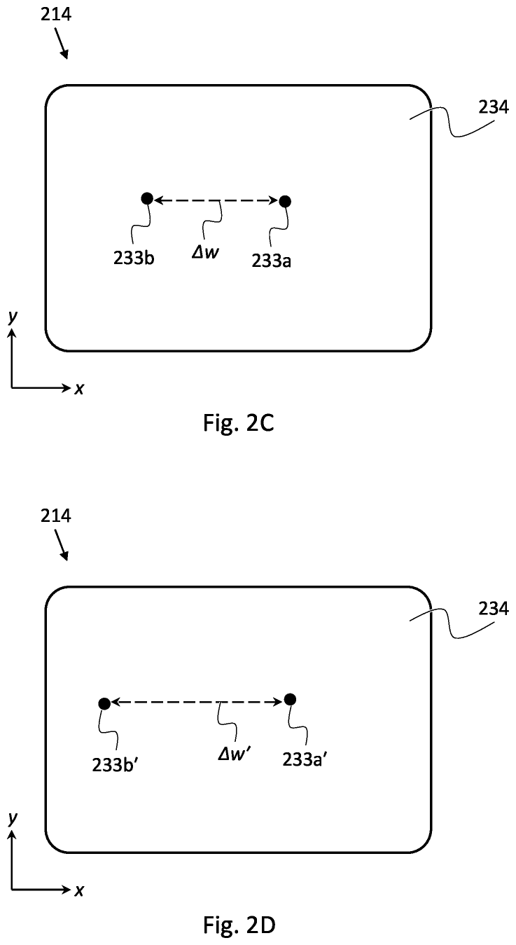

According to some embodiments, optical equipment 118 may include a plurality of blocking elements (such as the pair of blocking elements depicted in FIGS. 2A and 2B) configured to allow selectively blocking each of incident LBs 105, and thereby allow separately sensing of each of the returned LBs induced by first incident LB 105a and second incident LB 105b, respectively. As used herein, the term “blocking element”, with reference to an optical element, is be construed broadly as encompassing both controllably openable and closable opaque elements (such as shutters) configured to (when closed) block light beams incident thereon, and filtering elements (such as spectral filters) configured to block, whether fully or partially, one or more parts of an optical spectrum (e.g. the visible spectrum).

According to some embodiments, light source 112 may be configured to produce polychromatic light. According to some such embodiments, a spectrum of the light may be controllable. According to some embodiments, light source 112 may be configured to produce monochromatic light. In this regard it is noted that use of monochromatic light may be preferable when the LFC 102 is a prism and second incident LB 105b is generated so as to non-perpendicularly impinge on the prism (e.g. when first incident LB 105a is generated to non-perpendicularly impinge first surface 12a).

According to some embodiments, ICA 104 is or includes an autocollimator (i.e. light source 112, sensor 114, and some or all of optical equipment 118 constitute components of the autocollimator).

According to some embodiments, incident LBs 105 constitute adjacent sub-beams of a single, broad, and collimated LB generated by the autocollimator. According to such embodiments, optical equipment 118 may include an optical filter configured to transmit two sub-beams (such as incident LBs 105) of the collimated LB, prepared by the autocollimator and incident on the optical filter (with the parallelism of the two sub-beams being maintained on emergence from the optical filter).

According to some embodiments, light source 112 may be configured to produce a collimated laser beam. According to some such embodiments, optical equipment 118 may include a beam expander (not shown) configured to increase the diameter of the laser beam, such that the expanded laser beam may simultaneously impinge on both sample 10 and LFC 102. In such embodiments, first incident LB 105a and second incident LB 105b may constitute complementary portions of the laser beam. Alternatively, optical equipment 118 may include a beam splitter and optics configured to divide the laser beam into a pair of parallel (spaced-apart) sub-beams: a first sub-beam and a second sub-beam, which constitute first incident LB 105a and second incident LB 105b, respectively. According to some such embodiments, optical equipment 118 may be configured to recombine the returned sub-beams (i e. first returned LB 133a and second returned LB 133b), such that each of the sub-beams is redirected onto a single light sensor (i.e. sensor 114 according to some embodiments thereof) and is focused (e.g. using a lens or a lens arrangement) on a photosensitive surface of the light sensor. Ideally, if the second sub-beam (after redirection by LFC 122 and transmission into sample 10) perpendicularly impinges on internal facet 14, then the recombined sub-beams will form a collimated (second) laser beam and the two spots, formed by the returned sub-beams on the light sensor, will overlap. According to some other embodiments, two light sensors—such that the distance and a relative orientation therebetween, is known—may be employed. In such embodiments, each of the returned sub-beams may be directed to a different light sensor from the two light sensors.

According to some embodiments, ICA 104 may be configured for interferometry: Light source 112, some or all of optical equipment 118, and sensor 114 constitute components of an interferometric setup, as described below. In such embodiments, light source 112 may be configured to generate a coherent, planar wavefront. Optical equipment 118 may be configured to split the generated wavefront into two wavefronts: a first (coherent, planar) incident wavefront and a second (coherent, planar) incident wavefront, which constitute first incident LB 105a and second incident LB 105b, respectively.

According to some embodiments, LFC 102 is or includes a prism, one or more mirrors, and/or a diffraction grating. According to some embodiments, LFC 102 is a pentaprism or a like-function prism that is insensitive to variations in pitch (in the sense that the light folding angle thereof remains unchanged when the pitch of the LFC is slightly changed, i.e. when LFC 102 is slightly rotated about the y-axis).

According to some embodiments, system 100 may further include orienting infrastructure 120 for orienting sample 10 relative to ICA 104. As a non-limiting example, orienting infrastructure 120 may be in the form of a stage 122 mounted on a base 124. Stage 122 is configured for mounting thereon a sample, such as sample 10. Base 124 is configured to orient and, optionally, translate stage 122. According to some embodiments, base 124 may be configured to afford manipulation of sample 10 in each of six degrees of freedom (i.e. translations in any direction, and rotations about the yaw axis, and (at least limited) rotations about the pitch and roll axes). In particular, orienting infrastructure 120 may be configured to orient sample 10, such that first incident LB 105a will perpendicularly impinge on first surface 12a, and such that a folded LB 113b—obtained by the impinging of second incident LB 105b on LFC 102—will nominally perpendicularly impinge on second surface 12b. According to some embodiments, orienting infrastructure 120 may be functionally associated with controller 108 and is configured to be controlled thereby.

As used herein, according to some embodiments, the terms “nominally” and “ideally” may be interchangeable. An object may be said to “nominally” exhibit (i.e. be characterized by) an intrinsic property, such as an inclination angle between flat surfaces of the sample, when the object is intended by design and fabrication to exhibit the property but, in practice, due to manufacturing tolerances, the object may actually only imperfectly exhibit the property. The same applies to an extrinsic property of an object, such as the light propagation direction of a light beam. In this case, it is to be understood that the object has intentionally been prepared, or otherwise manipulated, to ideally exhibit the property but, in practice, due to inherent imperfections, e.g. in a setup used for the preparation, the object may actually only imperfectly exhibit the property.

In operation, first incident LB 105a is directed at sample 10 and second incident LB 105b is directed at LFC 102. According to some embodiments, and as depicted in FIG. 1A, first incident LB 105a is incident on first surface 12a perpendicularly thereto. First incident LB 105a (or at least a portion thereof) is reflected off first surface 12a—as indicated by a first returned LB 125a—and is sensed by sensor 114.

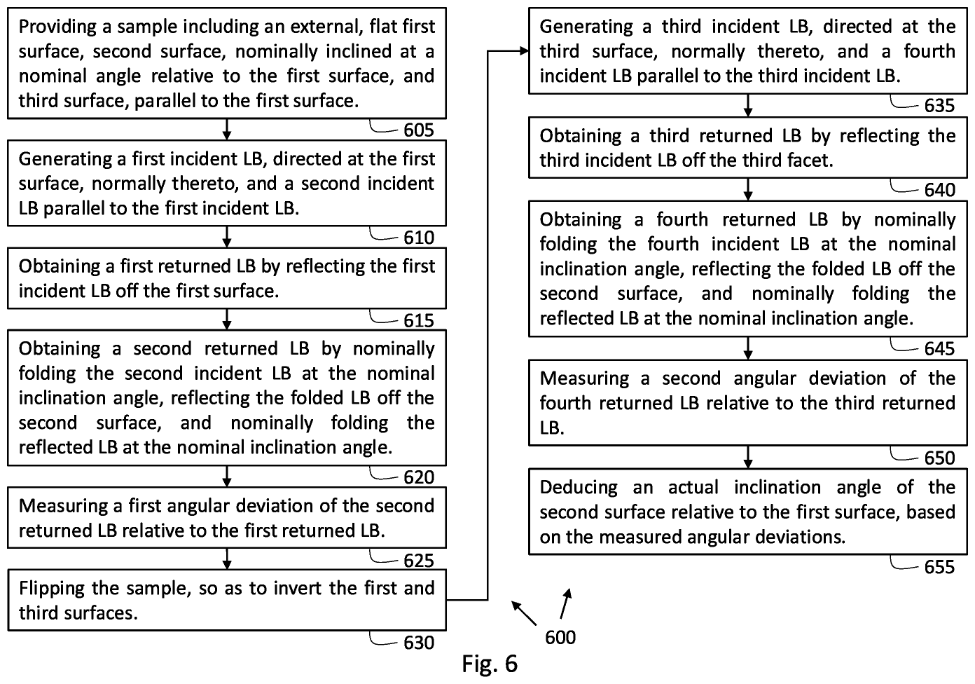

Second incident LB 105b is directed at LFC 102. LFC 102 is nominally configured to fold second incident LB 105b at the nominal inclination angle α. More precisely, LFC 102 is configured to “fold” (i.e. redirect) second incident LB 105b, such that folded LB 113b (obtained by the folding of second incident LB 105b) is nominally directed at the nominal inclination angle α relative to second incident LB 105b and (nominally) perpendicularly to second surface 12b. In practice, due to manufacturing imperfections, an actual light folding angle α″ of LFC 102 may slightly deviate from the nominal inclination angle α. When the uncertainty in the light folding angle (due to the manufacturing tolerance) of LFC 102 is significantly lower than the accuracy to which the actual inclination angle of second surface 12b is to be determined, the uncertainty in the light folding angle may be neglected (i.e. LFC 102 may be assumed to fold second incident LB 105a at precisely the nominal inclination angle α). Otherwise, the uncertainty in the light folding angle will contribute (non-negligibly) to the overall uncertainty in the measured value of the actual inclination angle, unless the nominal inclination angle is equal to 90°, in which case, through the implementation of additional measurements with the sample flipped, the deviation in the actual folding angle may be discounted, as detailed below in the description of FIGS. 2A and 2B and in the description of FIG. 6.

In order to keep the figures uncumbersome, only two light rays of each light beam are typically indicated. Further, the depiction of the light beams is schematic, and it is to be understood that depicted light beams may be wider or narrower than drawn. Thus, for example, according to some embodiments, first incident LB 105a may impinge over all of first surface 12a, and/or second incident LB 105b may impinge over all of a light receiving surface of LFC 102.

Folded LB 113b impinges on second surface 12b at an incidence angle θ. Angles are measured clockwise from the point-of-view of a reader perusing the figures. Values of angles greater than 180° being set to negative by subtracting 360°. Thus, as a non-limiting example intended to facilitate the description by making it more concrete, in FIG. 1A, the incidence angle θ is negative and the return angle (i.e. the reflection angle) is positive. More precisely, the incidence angle θ is shown spanned counter-clockwise from a dotted line B—which indicates a normal to second surface 12b—to a light ray 113b1 (one of the two light rays indicating folded LB 113b in FIG. 1A). The inclination angles α and α′ are measured clockwise from first surface 12a (as a non-limiting example, intended to facilitate the description, in FIG. 1A α′ is shown as being greater than α). The nominal inclination angle α is spanned clockwise from first surface 12a to the dashed line L. The actual inclination angle α′ is spanned clockwise from first surface 12a to second surface 12b.

The incidence angle θ depends on the deviation Δα′=α−α′ (i.e. the deviation in the inclination of second surface 12b from the nominal inclination) and the deviation Δα″=α−α″ (i.e. the deviation in the actual light folding angle of LFC 102 from a). Absent any imperfections in system 100 (i.e. α″=α), the incidence angle θ would equal Δα′. Put differently, the incidence angle θ equals Δα′ to a precision dependent on the uncertainty in the actual light folding angle α″ and any other relevant uncertainties in parameters of LFC 102, ICA 104, and orienting infrastructure 120 (i.e. the orientation precision thereof). In particular, system 100 is configured to have output LB 113b nominally normally (i.e. perpendicularly) impinge on second surface 12b when Δα′=0. The magnitude of Δα′ (i.e. |Δα′|, wherein the brackets denote the absolute value) is indicated in FIG. 1A.

Folded LB 113b (or at least a portion thereof) is specularly reflected off second surface 12b (i.e. at a return angle θ_{R} equal to minus the incidence angle θ), as indicated by a reflected LB 117b. Reflected LB 117b travels back towards LFC 102 and is folded by LFC 102 at the actual light folding angle α″. More precisely, reflected LB 117b is redirected by LFC 102 towards ICA 104, as indicated by a second returned LB 125b. Second returned LB 125b is sensed by sensor 114.

Typically, due to the manufacturing imperfections of both sample 10 and LFC 102, second returned LB 125b will not be parallel to first returned LB 125a. An angle δ—also referred to as “the angular deviation”—between first returned LB 125a and second returned LB 125b equals 2·θ_{R}, and thus depends on Δα′. The angle δ is shown spanned clockwise from a light ray 105b1 (one of the two light rays indicating second incident LB 105b in FIG. 1A) to a light ray 125b1 (one of the two light rays indicating second returned LB 125b in FIG. 1A), and is therefore positive in FIG. 1A.

Referring also to FIG. 1B, FIG. 1B presents a schematic, perspective view sample of 10 during the inspection thereof by system 100. Also indicated in FIG. 1B are first incident LB 105a, first returned LB 133a, folded LB 113b (which is to be understood as nominally perpendicularly impinging on second surface 12b), and reflected LB 117b.

FIG. 1C schematically depicts a first spot 133a and a second spot 133b formed by first returned LB 125a and second returned LB 125b, respectively, on a photosensitive surface 134 of sensor 114, according to some embodiments. u₁ and u₂ are the horizontal coordinates (i.e. as measured along the x-axis) of first spot 133a and second spot 133b, respectively. (The coordinate system depicted in FIG. 1C is assumed to coincide with the coordinate system depicted in FIG. 1A up to a possible translation of the origin. The x-axis in FIG. 1C thus extends from second incident LB 105b to first incident LB 105a in parallel to first surface 12a.) The angle δ may be directly inferred from the difference Δu=u₂−u₁. As a non-limiting example, when the measurement is autocollimator-based (i.e. in embodiments wherein ICA 104 is or includes an autocollimator), δ=Δu/f, so that Δα′=−Δu/(2·f), wherein f is the focal length of the collimating lens of the autocollimator. (More precisely, Δα′ equals −Δu/(2·f) to a precision dependent on the uncertainty in the actual light folding angle α″ and any other relevant uncertainties in parameters of LFC 102, ICA 104, and orienting infrastructure 120).

According to some embodiments, and as depicted in FIG. 1C, the vertical coordinates (i.e. as measured along the y-axis) of first spot 133a and second spot 133b may slightly differ from one another due to LFC 102 and sample 10 being misaligned, e.g. in terms of the respective yaw (i.e. around the z-axis) angles thereof. Such potential misalignment may be minimized during calibration of system 100 using, for example, an autocollimator.

Alternatively, according to some embodiments, wherein ICA 104 is or includes an interferometric setup, the angle δ may be deduced from an interference pattern formed by first returned LB 125a and second returned LB 125b. More specifically, in such embodiments, first returned LB 125a constitutes a first returned wavefront, obtained from reflection of the first incident wavefront off first surface 12a, and second returned LB 125b constitutes a second returned wavefront, obtained by folding of the second incident wavefront by LFC 102, reflection off second surface 12b, and folding again by LFC 102. The returned wavefronts are recombined and an interference pattern thereof is measured by sensor 114. If the first wavefront and the second wavefront impinge normally on the respective surface (i.e. first surface 12a or second surface 12b, respectively), the recombined wavefront will form a uniform pattern on sensor 114. If second surface 12b deviates from the nominal inclination, then the recombined wavefront will form a periodic pattern on sensor 114. The deviation Δα′ may be deduced from the periodicity of the pattern.

According to some embodiments, controller 108 may be communicatively associated with a computational module 130. Computational module 130 may include a processor(s) and volatile and/or non-volatile memory components. The processor may be configured to receive from controller 130 sensor 114 data (i.e. the values of u₁ and u₂), and, based thereon, compute Δα′. Optionally, according to some embodiments, the processor may further be configured to compute an uncertainty in the (computed value of) Δα′ taking into account manufacturing tolerances and imperfections of LFC 102 (including the uncertainty in the actual light folding angle), ICA 104, and orienting infrastructure 120. According to some embodiments, computational module 130 may be included in system 100.

According to some embodiments, system 100 may further include two shutters (positioned similarly to the blocking elements in FIGS. 2A and 2B) configured to allow selectively blocking each of first returned LB 125a and second returned LB 125b, so that each of returned LBs 125 may be separately sensed (thereby facilitating attributing each of spots 133 to the returned LB that induced the spot).

According to some embodiments, first surface 12a and second surface 12b may be coated, or temporarily coated, by a reflective coating, so that light incident thereon is maximally reflected or reflection therefrom is at least increased. According to some embodiments, wherein light source 112 is configured to generate polychromatic light, first surface 12a may be coated a first coating configured to reflect light in a first spectrum, and second surface 12b (or LFC 102) may be coated by a second coating configured to reflect light in a second spectrum, which does not, or substantially does not, overlap with the first spectrum. In such embodiments, selective blocking of first returned LB 125a and second returned LB 125b may be implemented using a spectral filter or a spectral filter arrangement (optionally, instead of shutters), positioned such that each of returned LBs 125 is incident thereon, and configured to allow selectively blocking or at least partially blocking light in the second spectrum and first spectrum, respectively.

According to some alternative embodiments, a first (passive) spectral filter may be employed to filter first incident LB 105a into a first spectrum, and a second (passive) spectral filter may be employed to filter second incident LB 105b into a second spectrum. In such embodiments, in order to allow separately sensing each of returned LBs 125, an additional spectral filter, positioned between the spectral filters and sensor 114, and configured to allow selectively filtering therethrough light either in the first spectrum or the second spectrum, may be employed.

It is noted that the spectral filter or the spectral filter arrangement may be used decrease the signal associated with stray light, associated with any one incident LBs 105, arriving at sensor 114.

While in FIG. 1A, first surface 12a and second surface 12b are shown as sharing a common edge, it is to be understood that scope of the disclosure is not limited to metrology of so shaped samples. In particular, any sample including an external and flat first surface and an external and flat second surface inclined with respect to the first surface but which does not share a common edge therewith, may also undergo metrology utilizing system 100, as described above.

FIGS. 2A and 2B schematically depict an optical-based system 200 for validating perpendicularity of an external and flat surface of a sample relative to at least two other external and flat surfaces of the sample, which are parallel to one another, according to some embodiments. System 200 corresponds to specific embodiments of system 100. More specifically, FIG. 2A provides a side-view of system 200 and a sample 20 being inspected by system 200, according to some embodiments. Sample 20 may be an optical element, such as a prism, a waveguide, or a beam splitter. According to some embodiments, the prism may be shaped as a polyhedron. According to some embodiments, and as depicted in FIGS. 2A and 2B, a cross-section of sample 20, taken in parallel to the zx-plane, may define a polygon.

Sample 20 includes an external, flat first surface 22a, an external, flat second surface 22b, and an external, flat third surface 22c. First surface 22a and third surface 22c are nominally parallel by design. Further, sample 20 is manufactured to exhibit a nominal inclination angle of 90° between first surface 22a and second surface 22b. However, due to fabrication imperfections an actual inclination angle of second surface 22b relative to first surface 22a, labelled in FIGS. 2A and 2B as χ′, will generally differ from 90°.

It is noted that using state-of-the-art manufacturing techniques, (manufacturing) tolerances for the actual angle between surfaces, which are fabricated to be parallel, are significantly smaller than tolerances for the actual angle between surfaces, which are fabricated to be non-parallel. Hence, since first surface 22a and third surface 22c are manufactured to be parallel, the deviation from the parallelism thereof is expected to be negligible as compared to the deviation of the actual inclination angle χ′ from 90°. Accordingly, an actual angle ψ′ (also referred to as “the actual supplementary angle”) between second surface 22b and third surface 22c may be taken to equal 180°−χ′, i.e. the supplementary angle to the actual inclination angle χ′. (The nominal value of the actual supplementary angle ψ′ is 90°.)

System 200 includes a LFC 202 and an ICA 204. LFC 202 corresponds to specific embodiments of LFC 102 and is configured to nominally fold light by 90°. According to some embodiments, LFC 202 is a prism, one or more mirrors, or a diffraction grating, nominally configured to fold by 90° light incident thereon in a direction perpendicular to first surface 22a. According to some embodiments, LFC 202 is a pentaprism or a like-function prism (i.e. insensitive to variations in pitch).

ICA 204 corresponds to specific embodiments of ICA 104 and includes a light source (not shown), a sensor (not shown), and, optionally, optical equipment (not shown), which correspond to specific embodiments of light source 112, sensor 114, and optical equipment 118, respectively. According to some embodiments, ICA 204 includes an autocollimator 240. Autocollimator 240 may be configured to generate a collimated LB 201. A first incident LB 205a and a second incident LB 205b form sub-beams of LB 201. According to some embodiments, and as depicted in FIGS. 2A and 2B, ICA 204 may additionally include a pair of blocking elements 246a and 246b, allowing to selectively block each of first incident LB 205a and second incident LB 205b. According to some embodiments, each of blocking elements 246a and 246b may be a shutter (e.g. controllable by controller 208).

First incident LB 205a is directed at sample 20 and second incident LB 205b is directed at LFC 202. According to some embodiments, and as depicted in FIG. 2A, ICA 204 and sample 20 are positioned and oriented, such that first incident LB 205a is incident on first surface 22a perpendicularly thereto. First incident LB 205a (or at least a portion thereof) is reflected off first surface 22a—as indicated by a first returned LB 225a. First returned LB 225a is sensed by autocollimator 240.

LFC 202 is configured to nominally fold second incident LB 205b by 90°. More precisely, LFC 202 is configured to fold second incident LB 205b, such that a (first) folded LB 213b (obtained by the folding of second incident LB 205b) is nominally directed at 90° relative to second incident LB 205b and (nominally) perpendicularly to second surface 12b. In practice, due to manufacturing imperfections and alignment imprecision in embodiments wherein LFC 202 is sensitive to variations in pitch, an actual light folding angle χ″ of LFC 202 may slightly deviate from 90°. As elaborated on below, by flipping sample 20, so as to invert first surface 22a and third surface 22c (while maintaining a nominal orientation of second surface 22b relative to LFC 202), and repeating the measurement described in the description of FIG. 2B, the effect of manufacturing imperfections of LFC 202 may be cancelled out or substantially cancelled out.

Folded LB 213b impinges on second surface 22b at a first incidence angle ζ₁. The first incidence angle η₁ depends on the deviation Δχ′=90°−χ′ (i.e. the deviation in the inclination of second surface 22b from the nominal inclination), as well as the deviation Δχ″=90°−χ″ (i.e. the deviation in the actual light folding angle of LFC 202 from 90°). A normal to second surface 22b is indicated in FIG. 2A by a (straight) dotted line C₁.

Folded LB 213b (or at least a portion thereof) is specularly reflected off second surface 22b (i.e. at a return angle ζ₁ equal to minus the first incidence angle as indicated by a (first) reflected LB 217b. Reflected LB 217b travels back towards LFC 202 and is folded by LFC 202 at the actual light folding angle χ″ resulting in a second returned LB 225b. Second returned LB 225b is sensed by sensor 214.

An angle Γ₁ between second returned LB 225b and first returned LB 225a—also referred to as “the first angular deviation”—equals 2·ζ₁. The angle Γ₁ thus depends on Δχ′. FIG. 2C schematically depicts a first spot 233a and a second spot 233b formed by first returned LB 225a and second returned LB 225b, respectively, on a photosensitive surface 234 of autocollimator 240, according to some embodiments. w₁ and w₂ are the horizontal coordinates (i.e. as measured along the x-axis) of first spot 233a and second spot 233b, respectively. The angle Γ₁ may be directly inferred from the difference Δw=w₂−w₁.

Referring to FIG. 2B, as compared to FIG. 2A, sample 20 has been flipped such that first surface 22a and third surface 22c are inverted (while maintaining the nominal orientation of second surface 22b relative to LFC 202).

Third incident LB 205a′ is directed at sample 20, perpendicularly thereto, and fourth incident LB 205b′ is directed at LFC 202. Third incident LB 205a′ (or at least a portion thereof) is reflected off third surface 22c—as indicated by a third returned LB 225a′. Third returned LB 225b′ is sensed by sensor 214.

Fourth incident LB 205b′ impinges on LFC 202, resulting in a second folded LB 213b′. Second folded LB 213b′ impinges on second surface 22b at a second incidence angle 112. The second incidence angle η₂ depends on a deviation Δψ′=90°−ψ′ (i.e. the deviation of the actual supplementary angle ψ′ from 90°), as well as the deviation Δχ′=90°−χ″. A normal to second surface 22b is indicated in FIG. 2B by a (straight) dotted line C₂.

Fourth incident LB 205b′ is (at least in part) specularly reflected off second surface 22b (i.e. at a return angle ζ₂ equal to minus the second incidence angle η₂), as indicated by a second reflected LB 217b′. Second reflected LB 217b′ travels back towards LFA 202 and is folded by LFA 202 at the actual light folding angle χ″, as indicated by a fourth returned LB 225b′. Fourth returned LB 225b′ is sensed by sensor 214.

An angle Γ₂ between fourth returned LB 225b′ and third returned LB 225a′—also referred to as “the second angular deviation”—equals 2·ζ₂. The angle Γ₂ thus depends on Δψ′ and, thereby, on Δχ′ (since χ′+ψ′=180°, so that Δψ′=−Δχ′). FIG. 2D schematically depicts a third spot 233a ′ and a fourth spot 233b′ formed by third returned LB 225α′ and fourth returned LB 225b′, respectively, on photosensitive surface 234 of sensor 214, according to some embodiments. w₁′ and w₂′ are the horizontal coordinates of third spot 233a ′ and fourth spot 233b′, respectively. The angle Γ₂ may be directly inferred from the difference Δw′=w₂′−w₁′.

While in FIGS. 2C and 2D Δw and Δw′ are both shown as being negative (so that Γ₁ and Γ₂ are both negative), it is to be understood that generally Δw and Δw′ may have opposite signs (so that Γ₁ and Γ₂ will have opposite signs), or may both be positive (so that Γ₁ and Γ₂ are both positive).

Each of the measured angles Γ₁ and Γ₂ may be used to provide a respective estimate of the deviation angle Δχ′. Absent any imperfections in system 200, η₂ would equal −η₁ and Γ₁ would equal −Γ₂.

However, in practice, the two estimates will generally differ due to the actual light folding angle deviating from its nominal value. Since both Γ₁ and Γ₂ have the same (when the LFC is insensitive to variations in pitch), or substantially the same, dependence, the actual light folding angle χ″ (i.e. both Γ₁ and Γ₂ increase as χ″ is increased and decrease as χ″ is decreased), the deviation in the light folding angle may be cancelled out, or substantially cancelled out, by averaging over the two estimates of the deviation angle Δχ′. That is, <Δχ′> equals, or substantially equals, −(δ₁−δ₂)/4. In particular, in embodiments wherein ICA 204 is or includes an autocollimator, <Δχ′> equals, or substantially equals, −(Δw−Δw′)/(2·f₀), wherein f₀ is the focal length of the collimating lens of the autocollimator.

According to some embodiments, first surface 22a, second surface 22b, and third surface 22c may be coated, or temporarily coated, by a reflective coating, so that light incident thereon is maximally reflected or reflection therefrom is at least increased. According to some embodiments, wherein autocollimator 240 is configured to generate a polychromatic LB, first surface 12a and third surface 12c may be coated a first coating configured to reflect light in a first spectrum, and second surface 12b may be coated by a second coating configured to reflect light in a second spectrum, which differs from the first spectrum. In such embodiments, autocollimator 240 may include a spectral filter configured to allow selectively filtering therethrough light in the first spectrum or the second spectrum, thereby facilitating separately sensing each of returned LBs 225.

According to some embodiments, blocking elements 246a and 246b may be spectral filters (a specific example being dichroic filter) configured to block light in the second spectrum and the first spectrum. In such embodiments, in order to allow separately sensing each of returned LBs 225, an additional spectral filter, positioned between blocking elements 246 and autocollimator 240 or included in autocollimator 240, and configured to allow selectively filtering therethrough light in the first spectrum or the second spectrum, may be employed.

While in FIGS. 2A and 2B, second surface 22b is shown as extending from first surface 22a to third surface 22c, it is to be understood that scope of the disclosure is not limited to metrology of so shaped samples. In particular, any sample including an external, flat first surface, an external, flat second surface inclined with respect to the first surface, and an external, flat third surface parallel to the first surface, such that the second surface does not share a common edge with the first surface and/or does not share a common edge with the third surface, may also undergo metrology utilizing system 200, as described above.

According to some alternative embodiments, not depicted in FIGS. 2A and 2B, light source 212 and optical equipment 218 may be configured to produce an expanded (collimated) laser beam or a pair of parallel and spaced apart (collimated) laser beams, essentially as described above in the description of system 100. According to still other embodiments, ICA 204 may be or includes an interferometric setup, as described above in the description of system 100.

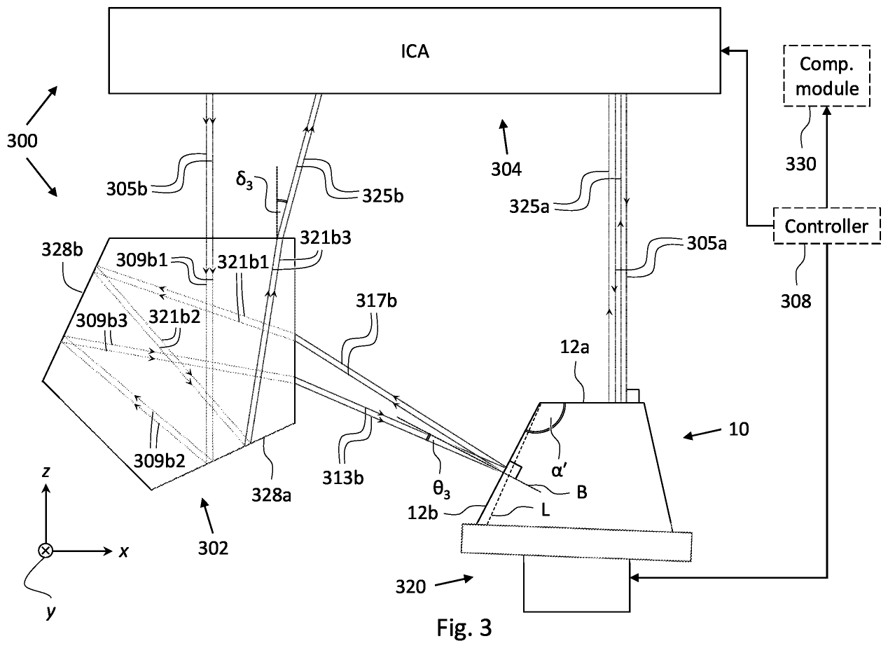

FIG. 3 schematically depict an optical-based system 300 for validating the angle between two external, flat surfaces of a sample, according to some embodiments. System 300 corresponds to specific embodiments of system 100, wherein the LFC is or includes a prism. More specifically, FIG. 3 provides a side-view of system 300 and sample 10 being inspected by system 300, according to some embodiments. System 300 includes a prism 302, an ICA 304 (components thereof are not shown), and orienting infrastructure 320. According to some embodiments, and as depicted in FIG. 3, system 300 further includes a controller 308, and, optionally, a computational module 330. Prism 302, ICA 304, orienting infrastructure 320, controller 308, and computational module 330 correspond to specific embodiments of LFC 102, ICA 104, orienting infrastructure 120, controller 108, and computational module 130, respectively.

According to some embodiments, prism 302 may be insensitive to variations in pitch - i.e. rotations about the y-axis—at least across a continuous range of pitch angles. According to some such embodiments, and as depicted in FIG. 3, prism 302 may be a pentaprism, or a like-function prism—e.g. a prism including an even number of internally reflecting surfaces. According to some alternative embodiments, not depicted in FIG. 3, instead of prism 322, system 300 may include two mirrors, set with respect to one another at the same angle at which the two surfaces of prism 302 (a pentaprism first surface 328a and a pentaprism second surface 328b), which internally reflect a transmitted portion of second incident LB 305b, are set.

Shown in FIG. 3 are a first incident LB 305a, a first returned LB 325a, a second incident LB 305b, a folded LB 313b, a reflected LB 317b, and a second returned LB 325b, which correspond to specific embodiments of first incident LB 105a, first returned LB 125a, second incident LB 105b, folded LB 113b, reflected LB 117b, and a second returned LB 125b, respectively. Also shown are the trajectories of second incident LB 305b and reflected LB 317b inside prism 302 after entry thereof thereinto. Penetrating portions of second incident LB 305b after entry into prism 302, after reflection therein, and after two reflections therein, are numbered 309b1, 309b2, and 309b3, respectively. Penetrating portions of reflected LB 317b after refraction into prism 302, after reflection therein, and after two reflections therein, are numbered 321b1, 321b2, and 321b3, respectively.

An incidence angle of folded LB 313b on second surface 12b is labelled as θ₃. An angular deviation of second returned LB 325b from first returned LB 325a is labelled as δ₃.

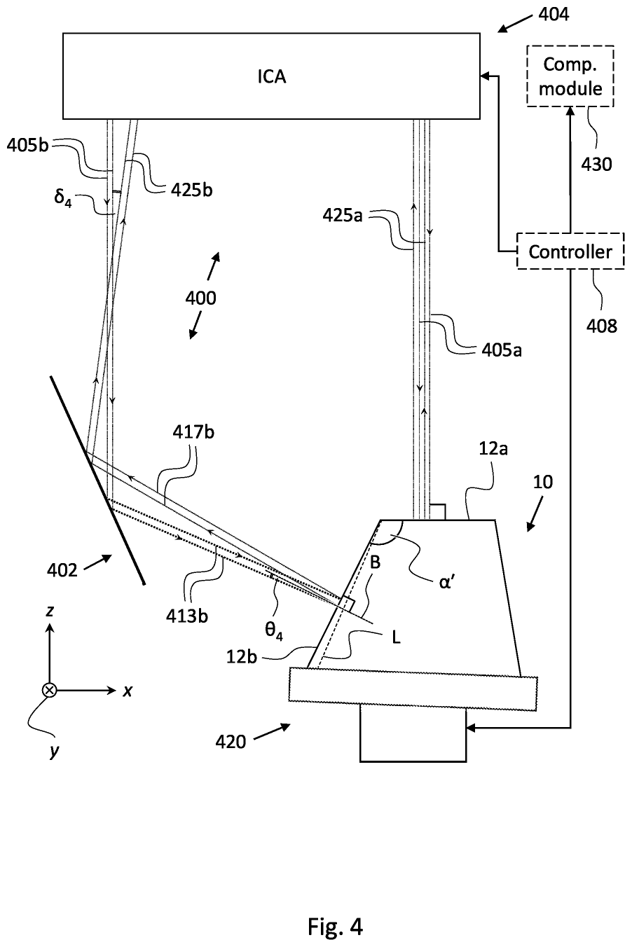

FIG. 4 schematically depict an optical-based system 400 for validating the angle between two external, flat surfaces of a sample, according to some embodiments. System 400 corresponds to specific embodiments of system 100, wherein the LFC is or includes a mirror. More specifically, FIG. 4 provides a side-view of system 400 and sample 10 being inspected by system 400, according to some embodiments. System 400 includes a mirror 402, an ICA 404 (components thereof are not shown), and orienting infrastructure 420. According to some embodiments, and as depicted in FIG. 4, system 400 further includes a controller 408, and, optionally, a computational module 430. Mirror 402, ICA 404, orienting infrastructure 420, controller 408, and computational module 430 correspond to specific embodiments of LFC 102, ICA 104, orienting infrastructure 120, controller 108, and computational module 130, respectively.

According to some embodiments, and as depicted in FIG. 4, mirror 402 may be a plane mirror.

Indicated in FIG. 4 are a first incident LB 405a, a first returned LB 425a, a second incident LB 405b, a folded LB 413b, a reflected LB 417b, and a second returned LB 425b, which correspond to specific embodiments of first incident LB 105a, first returned LB 125a, second incident LB 105b, folded LB 113b, reflected LB 117b, and a second returned LB 125b, respectively.

An incidence angle of folded LB 413b on second surface 12b is labelled as θ₄. An angular deviation of second returned LB 425b from first returned LB 425a is labelled as δ₄.

### Methods

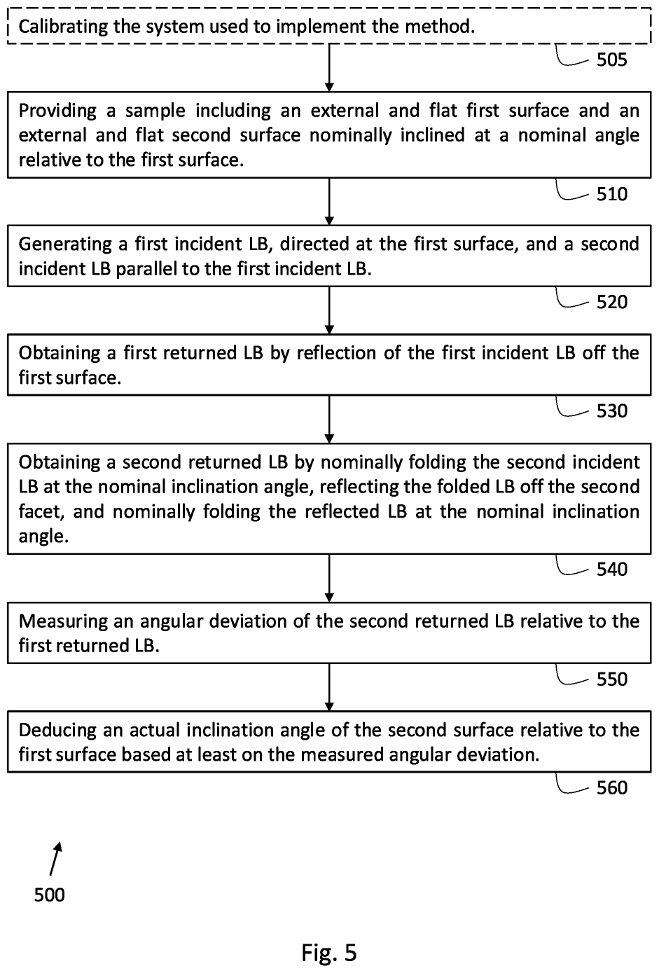

According to an aspect of some embodiments, there is provided an optical-based method for metrology of external, flat surfaces of samples. The method may be employed to validate an orientation of one external and flat surface of a sample relative to another external and flat surface of the sample. FIG. 5 presents a flowchart of such a method, an optical-based method 500, according to some embodiments. Method 500 may include:
An optional stage 505, wherein the system (e.g. system 100) used to implement the method is calibrated.
A stage 510, wherein a sample (e.g. sample 10), which is to be tested, is provided. The sample includes: an external, flat first surface (e.g. first surface 12a) and an external, flat second surface (e.g. second surface 12b) nominally inclined at a nominal inclination angle (e.g. the nominal inclination angle a) relative to the first surface.
A stage 520, wherein a first incident LB (e.g. first incident LB 105a), directed at the first surface, and a second incident LB (e.g. second incident LB 105b), parallel to the first incident LB, are generated (e.g. by light source 112 and optical equipment 118).

A stage 530, wherein a first returned LB (e.g. first returned LB 125a) is obtained by reflecting the first incident LB off the first surface.
A stage 540, wherein a second returned LB (e.g. second returned LB 125b) is obtained by nominally folding the second incident LB at a light folding angle equal to the nominal inclination angle, reflecting the folded LB (e.g. folded LB 113b) off the second surface, and nominally folding the reflected LB (e.g. reflected LB 117b) at the light folding angle.
A stage 550, wherein an angular deviation of the second returned LB relative to the first returned LB is measured (e.g. using sensor 114 or autocollimator 240).
A stage 560, wherein an actual inclination angle of the second surface relative to the first surface is deduced based at least on the measured angular deviation.

As used herein, the term “obtaining” may be employed both in an active and a passive sense. Thus, for example, in stage 540 the first returned LB may be obtained not due to any operation implemented in stage 540 but rather due to the generation of the first incident LB in stage 520. Generally, a stage may describe an active operation performed by a user or by the system used to implement the method, and/or the results or effects of one or more operations performed in one or more earlier stages.

Method 500 may be implemented employing an optical-based system, such as any one of optical-based systems 100, 300, and 400, or optical-based systems similar thereto, as described above in the respective descriptions thereof. In particular, according to some embodiments, method 500 may be autocollimator-based, based on the measurement of distance between laser beams, or may be based on interferometry, as detailed in the description of the various embodiments of system 100. In stage 540, the folded LB may be obtained from the second incident LB utilizing any one of LFC 102, prism 302, and minor 402, or a similar function LFC. Similarly, the second returned LB may be obtained from the reflected LB utilizing any one of LFC 102, prism 302, and mirror 402, or a like-function LFC.

According to some embodiments, in stage 520 the first incident LB may be projected on the first surface normally (i.e. perpendicularly) to the first surface. Accordingly, in such embodiments, the folded LB (obtained from the folding of the second incident LB) will nominally normally impinge on the second surface. According to some embodiments, in stage 505, “gold standard” (GS) samples may be employed as part of the calibration the system used to implement method 500. More specifically, given a sample to be tested, a corresponding GS sample (i.e. a sample that is known to exhibit the requisite geometry to high precision) may be employed in calibrating the system. In particular, the GS sample may be employed to align an orientable stage (e.g. stage 122), on which the sample is mounted, and the LFC, such that the folded LB perpendicularly impinges (to the precision afforded by the GS sample) on a second surface (analogous to second surface 12b) of the GS sample. The GS sample may further be employed to orient the stage, such that the first incident LB impinges perpendicularly on a first surface (analogous to first surface 12a) of the GS sample. An autocollimator, whether part of the ICA (e.g. ICA 104) of the system, or not included in the system, may be used to perform the alignment and to validate the perpendicularity of the first incident LB.

According to some embodiments, calibration or additional calibration may be performed after stage 510, once the sample to be tested has been provided and disposed e.g. on the orientable stage. The additional calibration may include, for example, orienting or re-orienting the stage (e.g. using an autocollimator) such that the first incident LB perpendicularly impinges on the first surface (of the sample to be tested).

According to some embodiments, in stage 520, an autocollimator (e.g. autocollimator 240) may be employed to generate a single incident LB, of which the first incident LB and the second incident LB constitute sub-beams. Alternatively, an expanded (collimated) laser beam may be generated, of which the first incident LB and the second incident LB constitute sub-beams. Still according to some other embodiments, a pair of parallel and spaced-apart laser beams may be generated, to which the first incident LB and the second incident LB respectively correspond.

According to some embodiments, in stages 530 and 540 an autocollimator (e.g. autocollimator 240, and, more generally, in embodiments wherein an autocollimator is used in preparing the incident LBs, that same autocollimator) may be employed to sense the returned LBs. According to some embodiments, shutters and/or spectral filters may be employed to selectively block, or partially block, the first returned LB or the second returned LB, essentially as described above in the description of FIG. 1A and FIGS. 2A and 2B. Beyond facilitating the attribution of each of a pair of spots (on a photosensitive surface of a light or image sensor (e.g. sensor 114) utilized to sense the returned LB s) to the returned LB, which has formed the spot, the blocking of one returned LB, while sensing the other returned LB, may serve to increase measurement precision by attenuating the signal associated with stray light.

According to some embodiments, particularly embodiments wherein stages 520, 530, and 540 are implemented employing an autocollimator (such as autocollimator 240), in stage 550, the angular deviation \tilde{δ} of the second returned LB relative to the first returned LB is computed via \tilde{δ}=(ũ₂−ũ₁)/\tilde{f}. ũ₁ and ũ₂ are the horizontal coordinates of a first spot and a second spot (e.g. first spot 133a and second spot 133b) formed on a photosensitive surface (e.g. photosensitive surface 134) of the autocollimator by the first returned LB and the second returned LB, respectively. \tilde{f} is the focal length of a collimating lens of the autocollimator.

In stage 560, the value of an actual inclination angle \tilde{α}′ if may be obtained from the (value of the) angular deviation \tilde{δ} via the relation \tilde{α}′=\tilde{α}−Δ\tilde{α}′=\tilde{α}+\tilde{δ}/2, wherein \tilde{α} is the nominal inclination angle of the second surface relative to the first surface (per the definition of angles—adopted in the description of FIGS. 1A-4—as increasing clockwise). More generally, \tilde{α}′ may equal about , \tilde{α}+\tilde{δ}/2, e.g. \tilde{α}′ may be between \tilde{α}+0.475·δ and \tilde{α}+0.525·δ, between \tilde{α}+0.45·δ and \tilde{α}+0.55·δ, \tilde{δ}, or even between \tilde{α}+0.4·δ and \tilde{α}+0.6·δ. Each possibility corresponds to separate embodiments. According to some embodiments, an uncertainty in the actual inclination angle may further be computed in stage 560, based at least on manufacturing tolerances and imperfections of the ICA configured to generate the incident LBs and measure the angular deviation between the returned LBs. According to some embodiments, the uncertainty in the inclination angle may be computed additionally taking into account the uncertainty in the folding angle \tilde{α}″.

FIG. 6 presents a flowchart of an optical-based method 600 for external, flat surface-metrology of samples, according to some embodiments. Method 600 corresponds to specific embodiments of method 500 and may be employed to validate perpendicularity of an external and flat surface of a sample relative to at least two other external and flat surfaces of the sample, which are parallel to one another. Method 600 may include:
A stage 605, wherein a sample (e.g. sample 20) to be tested is provided. The sample includes an external, flat first surface (e.g. first surface 22a), an external, flat second surface (e.g.

second surface 22b) nominally inclined at a nominal inclination angle relative to the first surface, and an external, flat third surface (e.g. third surface 22c) parallel to the first surface.
A stage 610, wherein a first incident LB (e.g. first incident LB 205a), directed normally to the first surface, and a second incident LB (e.g. second incident LB 205b), parallel to the first incident LB, are generated (e.g. by autocollimator 240).
A stage 615, wherein a first returned LB (e.g. first returned LB 225a) is obtained from a reflection of the first incident LB off the first surface.
A stage 620, wherein a second returned LB (e.g. second returned LB 225b) is obtained by nominally folding the second incident LB at a light folding angle equal to the nominal inclination angle, reflecting the folded LB (e.g. first folded LB 213b) off the second surface, and nominally folding the reflected LB (e.g. first reflected LB 217b) at the light folding angle.
A stage 625, wherein a first angular deviation of the second returned LB relative to the first returned LB is measured.
A stage 630, wherein the sample is flipped, so as to invert the first and third surfaces, while maintaining a nominal orientation of the second surface.
A stage 635, wherein a third incident LB (e.g. third incident LB 205a′), directed normally to the third surface, and a fourth incident LB (e.g. fourth incident LB 205b′), parallel to the third incident LB, are generated (e.g. by autocollimator 240).
A stage 640, wherein a third returned LB (e.g. third returned LB 225a′) is obtained from a reflection of the third incident LB off the third surface.
A stage 645, wherein a fourth returned LB (e.g. fourth returned LB 225b′) is obtained by nominally folding the fourth incident LB at the light folding angle, reflecting the folded LB (e.g. second folded LB 213b′) off the second surface, and nominally folding the reflected LB (e.g. second reflected LB 217b′) at the light folding angle.
A stage 650, wherein a second angular deviation of the fourth returned LB and the third returned LB is measured.
A stage 655, wherein an actual inclination angle of the second surface relative to the first surface is deduced based on the measured first angular deviation and second angular deviation.

Method 600 may be implemented employing an optical-based system, such as optical-based systems 200 or an optical-based system similar thereto, as described above in the description of FIGS. 2A-2D. In particular, according to some embodiments, method 600 may be autocollimator-based, based on the measurement of distance between laser beams, or based on interferometry. In stage 620, the first folded LB and the second returned LB may be obtained from the second incident LB and the first reflected LB, respectively, utilizing LFC 202 or a like-function LFC. The LFC may be or include a prism (e.g. a pentaprism), a mirror, or a diffraction grating, nominally configured to fold by 90° light incident thereon in a direction perpendicular to first surface 22a Similarly, in stage 645, the second folded LB and the fourth returned LB may be obtained from the fourth incident LB and the second reflected LB, respectively, utilizing LFC 202 or a like-function LFC.

According to some embodiments, method 600 may include an optional calibration stage (not shown in FIG. 6) similar to stage 505 of method 500.

According to some embodiments, in stages 610 and 635, an autocollimator (e.g. autocollimator) may be used to generate the pairs of parallel incident LBs. According to some embodiments, in stages 615, 620, 640, and 645 an autocollimator (e.g. the autocollimator used in preparing the incident LBs) may be employed to sense the returned LBs. According to some embodiments, shutters and/or spectral filters may be employed to selectively block, or partially block, one of the second returned LB and the first returned LB, and one of the fourth returned LB and the third returned LB, essentially as described above in the description of FIGS. 2A and 2B.

According to some embodiments, particularly embodiments wherein stages 610, 615, 620, 635, 640, and 645 are implemented employing an autocollimator (such as autocollimator 240), in stage 625, the first angular deviation \tilde{δ}₁ of the second returned LB relative to the first returned LB is obtained via \tilde{δ}₁=(\tilde{w}₂−\tilde{w}₁)/\tilde{f}₀. \tilde{w}₁ and \tilde{w}₂ are the horizontal coordinates of a first spot and a second spot (e.g. first spot 233a and second spot 233b) formed on the photosensitive surface (e.g. photosensitive surface 234) of the autocollimator by the first returned LB and the second returned LB, respectively. \tilde{f}₀ is the focal length of a collimating lens of the autocollimator. Similarly, in stage 650, the second angular deviation \tilde{δ}₂ of the fourth returned LB relative to the third returned LB is obtained via \tilde{δ}₂=(\tilde{w}₂′−\tilde{w}₁′)/\tilde{f}₀. \tilde{w}₁′ and \tilde{w}₂′ are the horizontal coordinates of a third spot and a fourth spot (e.g. third spot 233a′ and fourth spot 233b′) formed on the photosensitive surface of the autocollimator by the third returned LB and the fourth returned LB, respectively.

In stage 655, the value of the actual inclination angle \tilde{χ}′ may be obtained from the (values of the) angular deviations \tilde{δ}₁ and \tilde{δ}₂ via the relation \tilde{χ}′=\tilde{χ}′+(\tilde{δ}₁−\tilde{δ}₂)/4. More generally, Δ\tilde{χ}′=\tilde{χ}−\tilde{χ}′ may equal about −(\tilde{δ}₁−\tilde{δ}₂)/4, e.g. Δ\tilde{χ}′ is between 0.235·(\tilde{δ}₂−\tilde{δ}₁)and 0.265·((\tilde{δ}₂−\tilde{δ}₁)), between 0.225·(\tilde{δ}₁−\tilde{δ}₂) and 0.275·(\tilde{δ}₁−\tilde{δ}₂), or even between 0.2·(\tilde{δ}₁−\tilde{δ}₂) and 0.3·(\tilde{δ}₁−\tilde{δ}₂). Each possibility corresponds to separate embodiments. According to some embodiments, an uncertainty in the actual inclination angle may further be computed in stage 655, based least on manufacturing tolerances and imperfections of the ICA configured to generate the incident LBs and measure the angular deviation between the returned LBs.

It is appreciated that certain features of the disclosure, which are, for clarity, described in the context of separate embodiments, may also be provided in combination in a single embodiment. Conversely, various features of the disclosure, which are, for brevity, described in the context of a single embodiment, may also be provided separately or in any suitable sub-combination or as suitable in any other described embodiment of the disclosure. No feature described in the context of an embodiment is to be considered an essential feature of that embodiment, unless explicitly specified as such.

Although stages of methods according to some embodiments may be described in a specific sequence, methods of the disclosure may include some or all of the described stages carried out in a different order. A method of the disclosure may include a few of the stages described or all of the stages described. No particular stage in a disclosed method is to be considered an essential stage of that method, unless explicitly specified as such.

Although the disclosure is described in conjunction with specific embodiments thereof, it is evident that numerous alternatives, modifications, and variations that are apparent to those skilled in the art may exist. Accordingly, the disclosure embraces all such alternatives, modifications, and variations that fall within the scope of the appended claims. It is to be understood that the disclosure is not necessarily limited in its application to the details of construction and the arrangement of the components and/or methods set forth herein. Other embodiments may be practiced, and an embodiment may be carried out in various ways.

The phraseology and terminology employed herein are for descriptive purpose and should not be regarded as limiting. Citation or identification of any reference in this application shall not be construed as an admission that such reference is available as prior art to the disclosure. Section headings are used herein to ease understanding of the specification and should not be construed as necessarily limiting.

What is claimed is:

1. An optical-based method for validating angles between external, flat surfaces of samples, the method comprising:
providing a sample comprising an external, flat first surface and an external, flat second surface nominally inclined at a nominal inclination angle relative to the first surface;
generating a first incident light beam (LB), directed at the first surface, and a second incident LB parallel to the first incident LB;
obtaining a first returned LB by reflection of the first incident LB off the first surface;
obtaining a second returned LB by folding the second incident LB at a light folding angle nominally equal to the nominal inclination angle, reflecting the folded LB off the second surface, and folding the reflected LB at the light folding angle;
measuring a first angular deviation of the second returned LB relative to the first returned LB; and
deducing an actual inclination angle of the second surface relative to the first surface, based at least on the measured first angular deviation.

2. The optical-based method of claim 1, wherein the first incident LB is directed at the first surface perpendicularly thereto.

3. The optical-based method of claim 2, wherein the folding is implemented utilizing a light folding component (LFC), which is or comprises a prism, whereing the prism comprises a pentaprsim or a line-function prism.

4. The optical-based method of claim 3, wherein the light folding angle is insensitive to variations in a pitch of the LFC.

5. (canceled)

6. (canceled)

7. (canceled)

8. The optical-based method of claim 1, wherein the second surface does not share a common edge with the first surface.

9. The optical-based method of claim 1, wherein the first incident LB and the second incident LB are complementary portions of a single collimated LB.

10. The optical-based method of claim 1, wherein the first incident LB and the second incident LB are prepared by blocking one or more portions of a single collimated LB.

11. (canceled)

12. (canceled)

13. The optical-based method of claim 1, wherein the first angular deviation is measured using an autocollimator, wherein the measured first angular deviation between the returned LBs is equal to, or about equal to, Δu/f, wherein Δu is a difference between a coordinate of a first spot and a corresponding coordinate of a second spot on a photosensitive surface of the autocollimator, f is the focal length of a collimating lens of the autocollimator, and wherein the first spot is formed by the first returned LB and the second spot is formed by the second returned LB.

14. (canceled)

15. (canceled)

16. The optical-based method of claim 1, wherein the nominal inclination angle is 90° and the sample comprises an external, flat third surface parallel to the first surface, wherein the first incident LB is directed at the first surface perpendicularly thereto, and wherein the method further comprises, following the measuring of the first angular deviation:
flipping the sample, so as to invert the first and third surfaces while maintaining a nominal orientation of the second surface relative to the LFC;
preparing a third incident LB, directed at the third surface, normally thereto, and a fourth incident LB parallel to the third incident LB;
obtaining a third returned LB by reflection of the third incident LB off the third surface;
obtaining a fourth returned LB by folding the fourth incident LB at a light folding angle nominally equal to the nominal inclination angle, reflection thereof off the second surface, and folding thereof at the light folding angle;
measuring a second angular deviation of the fourth returned LB relative to the third returned LB; and
wherein, in the deducing of the actual inclination angle, the actual inclination angle is deduced additionally taking into account the measured second angular deviation.

17. The optical-based method of claim 16, wherein an uncertainty in the parallelism of the first surface and the third surface is smaller than a required measurement precision of the actual inclination angle.

18. The optical-based method of claim 1, further comprising, contingent on the sample comprising an external, flat fourth surface, nominally parallel to the second surface, suppressing internal reflection from the fourth surface.

19. An optical-based system for validating angles between external, flat surfaces of samples, the system comprising:
a light folding component (LFC) nominally configured to fold light incident thereon at a nominal inclination angle defined by an external, flat first surface and an external, flat second surface of a sample; and
an illumination and collection arrangement (ICA) comprising:
a light generation assembly configured to (a) project a first incident light beam (LB) on the first surface, so as to generate a first returned LB by reflection off the first surface, and (b) project a second incident LB on the LFC, in parallel to the first incident LB, so as to generate a second returned LB, by folding by the LFC, reflection off the second surface, and repassage via the LFC; and
at least one sensor, configured to measure a first angular deviation of the second returned LB relative to the first returned LB, and/or an eyepiece assembly configured to enable manually measuring the first angular deviation; and
wherein the measured first angular deviation is indicative of an actual inclination angle of the second surface relative to the first surface.

20. The optical-based system of claim 19, configured to have the first incident LB normally impinge on the first surface.

21. The optical-based system of claim 20, wherein the system further comprises orienting infrastructure configured to orient the sample such that the first incident LB normally impinges on the first surface, and/or a folded LB, obtained by folding of the second incident LB by the LFC, nominally normally impinges on the second surface.

22. The optical-based system of claims 21, comprising the at least one sensor, and further comprising a computational module configured to compute the actual inclination angle of the second surface relative to the first surface, based at least on the measured first angular deviation.

23. The optical-based system of claim 22, wherein the ICA is or comprises an autocollimator, the autocollimator comprising the light source and the at least one sensor.

24. The optical-based system of claim 23, wherein the ICA further comprises a pair of blocking elements configured to allow selectively blocking each of the first incident LB and the second incident LB.

25. The optical-based system of claim 19, wherein the LFC comprises a prism, wherein the prism comprises a pentaprism pr a like-function prism.

26. The optical-based system of claim 19, wherein a light folding angle of the LFC is insensitive to variations in a pitch thereof.

27. (canceled)

28. The optical-based system of claim 19, wherein the light generation assembly comprises a light source and optical equipment, wherein the light source is configured to generate a single LB, and wherein the optical equipment is configured to collimate the single LB and wherein the first incident LB and the second incident LB are complementary portions of the collimated LB.

29-36. (canceled)
